(19) United States
(12) Patent Application Publication
(10) Pub. No.: US 2014/0232675 A1
(43) Pub. Date: Aug. 21, 2014

(54) INPUT APPARATUS AND INPUT APPARATUS PROCESSING METHOD

(71) Applicant: TOYOTA JIDOSHA KABUSHIKI KAISHA, Toyota-shi, Aichi-ken (JP)

(72) Inventors: Yasuhiko Yamamoto, Miyoshi-shi (JP); Masaharu Kinoshita, Kariya-shi (JP); Toshiyuki Tsutsumi, Toyota-shi (JP)

(73) Assignee: TOYOTA JIDOSHA KABUSHIKI KAISHA, Toyota-shi, Aichi-ken (JP)

(21) Appl. No.: 14/346,145

(22) PCT Filed: Sep. 20, 2012
(86) PCT No.: PCT/IB2012/001839

§ 371 Date: Mar. 20, 2014

(30) Foreign Application Priority Data
Sep. 22, 2011 (JP) 2011-207454

(51) Int. Cl. G06F 3/041

(52) U.S. Cl. CPC G06F 3/0416
USPC 345/173

(57) ABSTRACT

An input apparatus includes: a display unit (20) that displays a set value relating to a control item of a control apparatus (60, 80); a touch panel (30) that detects a touch operation; a processing unit (40) configured to modify the set value displayed on the display unit (20) according to the touch operation, and output a signal indicating the modified set value to the control apparatus (60, 80); and a measurement unit (40) that measures a time interval between the touch operation and a previous touch operation, wherein the processing unit (40) is configured to modify a variation amount by which the set value is varied such that the variation amount when the time interval is smaller than a threshold and the variation amount when the time interval equals or exceeds the threshold differ from each other.

### BACKGROUND OF THE INVENTION

1. Field of the Invention

The invention relates to an input apparatus for performing input by a touch operation, and a processing method thereof.

2. Description of Related Art

An automobile front panel having an inbuilt input apparatus for adjusting a sound volume of an audio apparatus or adjusting a temperature of an air-conditioning apparatus, in which a display device and a touch panel are provided, has been proposed in the related art. In this type of input apparatus, a current sound volume value of the audio apparatus is displayed on a display screen of the display device, for example. Every time a touch operation is performed in a sound volume setting region of the touch panel in order to adjust the sound volume of the audio apparatus, the touch operation is detected by the touch panel and an update signal for turning the sound volume up or down is output to the audio apparatus. At this time, the sound volume value displayed on the display screen is modified in accordance with a number of touch operations performed on the touch panel. The sound volume of the audio apparatus is modified in proportion to the number of update signals output from the input apparatus in accordance with the number of touch operations.

Further, every time a touch operation is performed in an air-conditioning apparatus temperature setting region of the touch panel of the input apparatus in order to set the temperature of the air-conditioning apparatus, for example, an update signal is similarly output to a controller of the air-conditioning apparatus. The controller then controls the air-conditioning temperature in accordance with a set temperature in accordance with the number of output update signals. Moreover, the set temperature displayed on the display screen is increased or reduced with every touch operation (to be referred to hereafter as Related Art 1).

A portable terminal apparatus including a touch panel is available as an apparatus for performing input through touch panel operations (Japanese Patent Application Publication No. 2003-330613 (JP 2003-330613 A)). It is described in JP 2003-330613 A that when a drag operation is performed on the touch panel, a scrolling speed of a display screen is modified in accordance with a speed (drag speed) of the drag operation (to be referred to hereafter as Related Art 2).

In the input apparatus of Related Art 1, a set value of the sound volume of the audio apparatus and a set value of the temperature of the air-conditioning apparatus are modified by equal amounts every time a touch operation is performed on the touch panel. Therefore, to make large modifications or very small adjustments from a current set value, the number of touch operations may be increased, for example, leading to poor operability.

Related Art 2 is advantaged in that the scrolling speed of a display subject can be modified in accordance with the drag speed. Incidentally, in Related Art 2, the scrolling speed of the display subject can be modified by modifying the drag speed during the drag operation. In other words, a scroll amount is modified in accordance with variation in the drag speed. To detect the drag speed, a region in which a touch operation can be performed using a stylus pen needs to be lengthened so that a movement distance of the stylus pen over the display screen of the portable terminal apparatus is increased. Therefore, when Related Art 2 is applied to Related Art 1 in order to modify a set value of the sound volume of the audio apparatus or the temperature of the air-conditioning apparatus, a touch operation detection region needs to be increased in length.

### SUMMARY OF THE INVENTION

The invention provides an input apparatus having a simple configuration, with which operability during an operation to modify a set value of a control item can be improved without the need to increase the length of a touch operation detection region, and a processing method thereof.

A first aspect of the invention is an input apparatus including: a display unit that displays a set value set in relation to a control item of a control apparatus; a touch panel that detects a touch operation; a processing unit configured to modify the set value displayed on the display unit in accordance with the touch operation detected by the touch panel, and output a signal indicating the modified set value to the control apparatus; and a measurement unit that measures a time interval between the touch operation and a previous touch operation, wherein the processing unit is configured to set a variation amount by which the set value is varied such that the variation amount of the set value when the time interval is smaller than a threshold and the variation amount of the set value when the time interval equals or exceeds the threshold differ from each other.

A second aspect of the invention is an input apparatus processing method including: detecting a touch operation on a touch panel; modifying a set value set in relation to a control item of a control apparatus, which is displayed by a display unit, in accordance with the touch operation detected by the touch panel; outputting a signal indicating the modified set value to the control apparatus; measuring a time interval between the touch operation and a previous touch operation; and setting a variation amount by which the set value is varied such that the variation amount of the set value when the time interval is smaller than a threshold and the variation amount of the set value when the time interval equals or exceeds the threshold differ from each other.

According to the configurations described above, an input apparatus having a simple configuration, with which operability during an operation to modify the set value of the control item can be improved without the need to increase the length of the touch panel, and a processing method thereof, can be provided. Further, the variation amount of the set value of the control item can be varied simply by changing the time interval between consecutive touch operations from a smaller time interval than the threshold to a time interval that equals or exceeds the threshold, or from a time interval that equals or exceeds the threshold to a smaller time interval than the threshold.

The processing unit may be configured to increase the variation amount of the set value when the time interval is smaller than the threshold above the variation amount of the set value when the time interval equals or exceeds the threshold.

According to this configuration, when the time interval from the previous touch operation is smaller than the threshold, the set value is increased by a larger variation amount than when the time interval from the previous touch operation equals or exceeds the threshold. As a result, the set value of the control item can be increased quickly.

When a plurality of short time interval touch operations, each of which is the touch operation with the time interval smaller than the threshold, are performed consecutively, the processing unit may be configured to increase the variation amount of the set value in accordance with the short time interval touch operation performed subsequently above the variation amount of the set value in accordance with the short time interval touch operation performed initially.

According to this configuration, when s second touch operation is performed subsequent to a first touch operation and each of the first operation and the second operation is the touch operation with the time interval from the previous operation smaller than the threshold, the variation amount of the set value in accordance with the second touch operation is increased above the variation amount of the set value in accordance with the first touch operation. As a result, the set value of the control item can be increased quickly.

The processing unit may be configured to reduce the variation amount of the set value when the time interval is smaller than the threshold below the variation amount of the set value when the time interval equals or exceeds the threshold.

According to this configuration, when the time interval from the previous touch operation is smaller than the threshold, the set value is reduced by a smaller variation amount than when the time interval from the previous touch operation equals or exceeds the threshold. As a result, fine reductions can be made to the set value of the control item.

When a plurality of short time interval touch operations, each of which the is the touch operation with the time interval smaller than the threshold, are performed consecutively, the processing unit may be configured to reduce the variation amount in accordance with the short time interval touch operation performed subsequently below the variation amount in accordance with the short time interval touch operation performed initially.

According to this configuration, when s second touch operation is performed subsequent to a first touch operation and each of the first operation and the second operation is the touch operation with the time interval from the previous operation smaller than the threshold, the variation amount of the set value in accordance with the second touch operation is reduced below the variation amount of the set value in accordance with the first touch operation. As a result, fine reductions can be made to the set value of the control item.

The touch panel may be disposed on a display screen of the display unit.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing an input apparatus according to a first embodiment of the invention;

FIG. 2 is a front view of a display screen of a display device in an air-conditioning control display mode;

FIG. 3 is a flowchart illustrating set value modification, which is implemented by a central processing unit (CPU) of the input apparatus;

FIG. 4 is a front view of the display screen of the display device in an audio control display mode; and

FIGS. 5A and 5B are illustrative views illustrating variation amounts of set values.

### DETAILED DESCRIPTION OF EMBODIMENTS

### First Embodiment

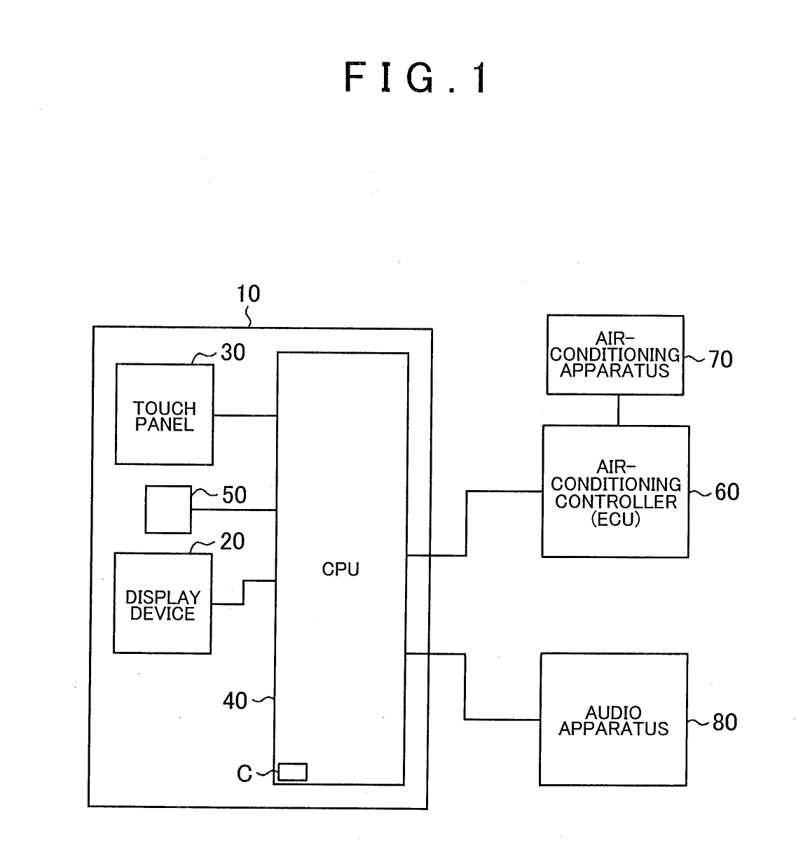

A first embodiment in which an input apparatus according to the invention is realized as an input apparatus of an air-conditioning apparatus 70 and an audio apparatus 80 provided in a vehicle will be described below with reference to FIGS. 1 to 4.

An input apparatus 10 shown in FIG. 1 is provided on a center console panel of a vehicle, not shown in the drawing. In this embodiment, the input apparatus 10 is disposed in a location where a person sitting in a driving seat or a front passenger seat can operate the input apparatus 10 easily. The input apparatus 10 is electrically connected to an air-conditioning controller 60 and the audio apparatus 80.

The air-conditioning controller 60 serves as a control apparatus that controls a spatial temperature inside a vehicle cabin. The audio apparatus 80 serves as a control apparatus that controls a sound volume. The input apparatus 10 includes a display device 20 serving as a display unit, a touch panel 30 provided on a display screen of the display device 20, and a CPU 40 that is electrically connected to the display device 20 and the touch panel 30. The CPU 40 serves as a processing unit.

The display device 20 is constituted by a liquid crystal display, an organic EL display, or a large number of light-emitting diodes, and is configured to display numerical values and the like in accordance with control signals output from the CPU 40. The touch panel 30 is disposed such that the display screen of the display device 20 is covered by a transparent panel. The touch panel 30 may employ an electrostatic capacitance method, a resistance film method, a surface acoustic wave method, an electromagnetic induction method, a matrix switch method, or another method.

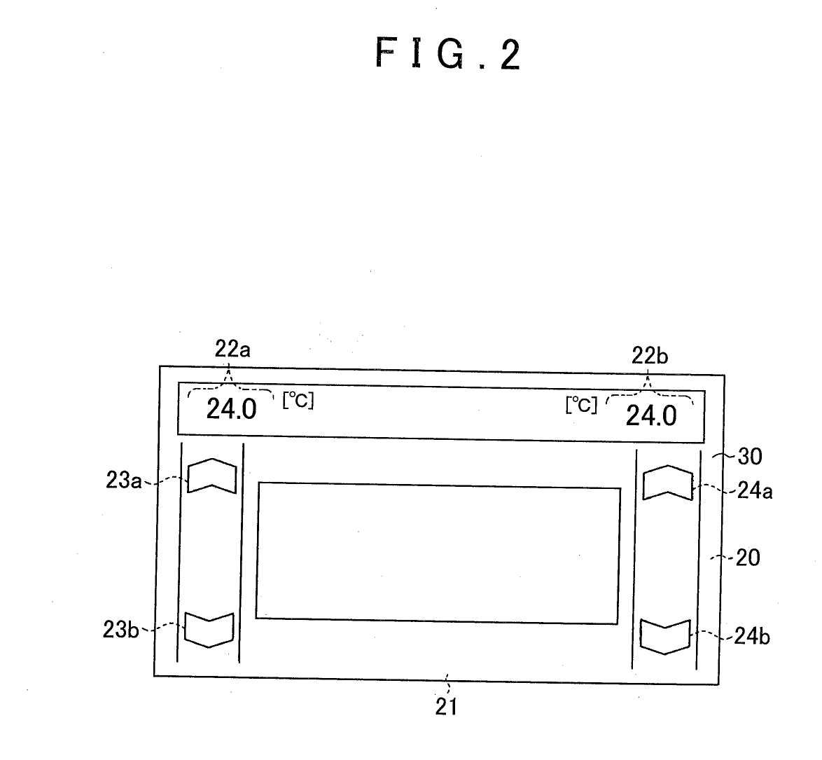

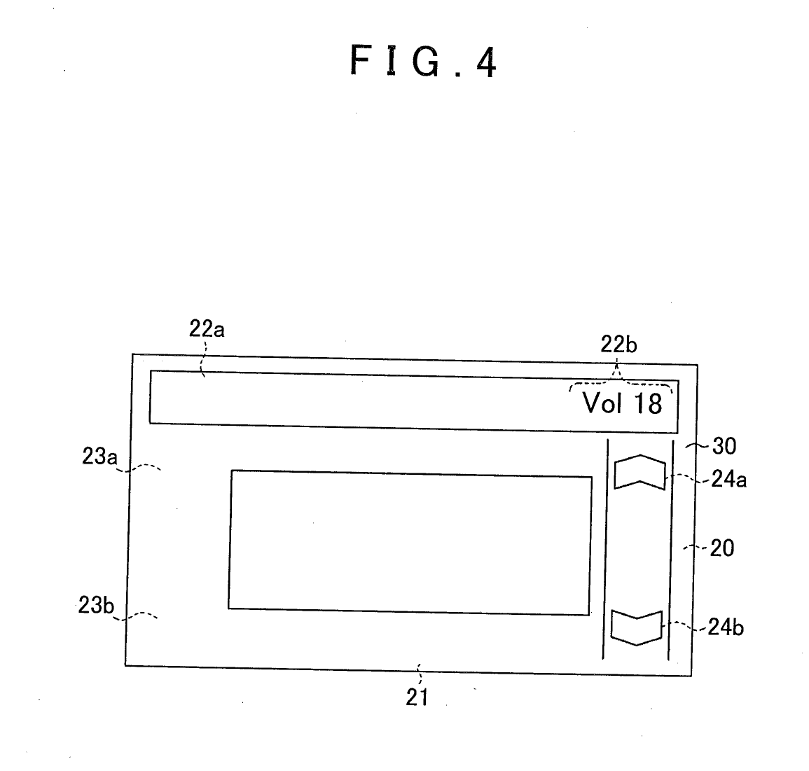

FIGS. 2 and 4 show a display screen 21 of the display device 20 through the touch panel 30. In FIGS. 2 and 4, for ease of description, dotted lines are drawn from reference numerals relating to the display device 20 and solid lines are drawn from reference numerals of parts relating to the touch panel 30.

The touch panel 30 is configured to detect touch operations (a tapping operation in which the touch panel 30 is tapped by a finger, an operation in which the finger is swept over the touch panel 30 (the finger is caused to slide over the touch panel 30), or in other words a flipping operation, and an operation in which the finger is moved while remaining pressed against the touch panel 30) performed in guide display regions 23a, 23b, 24a, 24b.

The display device 20 includes, as display modes, an air-conditioning control display mode and an audio control display mode. The input apparatus 10 is provided with a switch 50, and when a switch signal is input into the CPU 40 from the switch 50, the CPU 40 switches a current display mode of the display device 20 from one display mode to the other. For example, when the current display mode is the air-conditioning control display mode, the CPU 40 switches to the audio control display mode in response to the switch signal from the switch 50.

In the air-conditioning control display mode shown in FIG. 2, left side and right side regions in an upper portion of the display screen 21 of the display device 20 serve as display regions 22a, 22b displaying numerical values. A set value of the spatial temperature in the vehicle cabin on the side of the front passenger seat, not shown in the drawing, is displayed in the left side display region 22a. A set value of the spatial temperature in the vehicle cabin on the side of the driving seat, not shown in the drawing, is displayed in the right side display region 22b. Here, the set values of the spatial temperature in the vehicle cabin displayed in the display regions 22a, 22b are regarded as set values in relation to a control item of a control apparatus.

Further, in the air-conditioning control display mode, regions below the display regions 22a, 22b on the display screen 21 of the display device 20 are defined as operation direction guide display regions 23a, 23b, 24a, 24b. A shape (an arrow shape, for example) indicating a touch operation direction (input operation direction) for raising the set value of the temperature is displayed in the operation direction guide display region 23a. A shape indicating a touch operation direction (input operation direction) for lowering the set value of the temperature is displayed in the operation direction guide display region 23b.

In the air-conditioning control display mode, the CPU 40 of the input apparatus 10 outputs a temperature setting signal in accordance with the set value of the temperature, which has been modified by a touch operation, to the air-conditioning controller 60 of the air-conditioning apparatus 70. The air-conditioning controller 60 controls the control subject air-conditioning apparatus 70 on the basis of the temperature setting signal. In other words, when the temperature setting signal indicates that the set value is to be increased, the air-conditioning controller 60 controls the air-conditioning apparatus 70 such that the spatial temperature in the vehicle cabin is increased to a modified set value. Further, when the temperature setting signal indicates that the set value is to be reduced, the air-conditioning controller 60 controls the air-conditioning apparatus 70 such that the spatial temperature in the vehicle cabin is reduced to a modified set value. Note that specific content of this control is available in the related art, and therefore description thereof has been omitted. In this embodiment, temperature setting can be performed on both the driving seat side and the front passenger seat side. Hence, the air-conditioning controller 60 controls the spatial temperature in the vehicle cabin on both the driving seat side and the front passenger seat side to the set value of the temperature displayed in the display region 22a and the set value of the temperature displayed in the display region 22b.

When a touch operation (i.e. an input operation) is performed in a site of the touch panel 30 corresponding to the display regions 23a, 23b, 24a, 24b of the display device 20 in the air-conditioning control display mode, the touch panel 30 inputs a position detection signal indicating that a touch operation has been detected in the corresponding display region into the CPU 40.

The audio control display mode shown in FIG. 4 differs partially from the air-conditioning control display mode. Therefore, parts that differ from the air-conditioning control display mode will be described while allocating identical reference numerals to configurations and regions that are identical to the air-conditioning control display mode.

As shown in FIG. 4, in the audio control display mode, nothing is displayed in the left side display region 22a in the upper portion of the display screen 21 of the display device 20, and a set value of a sound volume of the audio apparatus 80 is displayed in the right side display region 22b. The set value of the sound volume displayed in the display region 22b are regarded as the set value in relation to the control item of the control apparatus.

Further, in the audio control display mode, nothing is displayed in the operation direction guide display regions 23a, 23b on the display screen 21 of the display device 20, while in the operation direction guide display regions 24a, 24b, a shape (an arrow shape, for example) indicating an operation direction is displayed. More specifically, a shape indicating a touch operation direction for increasing the set value of the sound volume is displayed in the operation direction guide display region 24a, while a shape indicating a touch operation direction for lowering the set value of the sound volume is displayed in the operation direction guide display region 24b.

In the audio control display mode, the CPU 40 of the input apparatus 10 outputs a sound volume setting signal in accordance with the set value of the sound volume, which has been modified by a touch operation, to the audio apparatus 80. The audio apparatus 80 controls the sound volume on the basis of the sound volume setting signal. More specifically, when the sound volume setting signal indicates that the set value is to be increased, the audio apparatus 80 increases the sound volume to the modified set value, and when the sound volume setting signal indicates that the set value is to be reduced, the audio apparatus 80 reduces the sound volume to the modified set value. Note that specific content of this control is available in the related art, and therefore description thereof has been omitted.

When a touch operation (i.e. an input operation) is performed in a site of the touch panel 30 corresponding to the display regions 24a, 24b of the display device 20 in the air-conditioning control display mode, the touch panel 30 inputs a position detection signal indicating that a touch operation has been detected in the corresponding display region into the CPU 40.

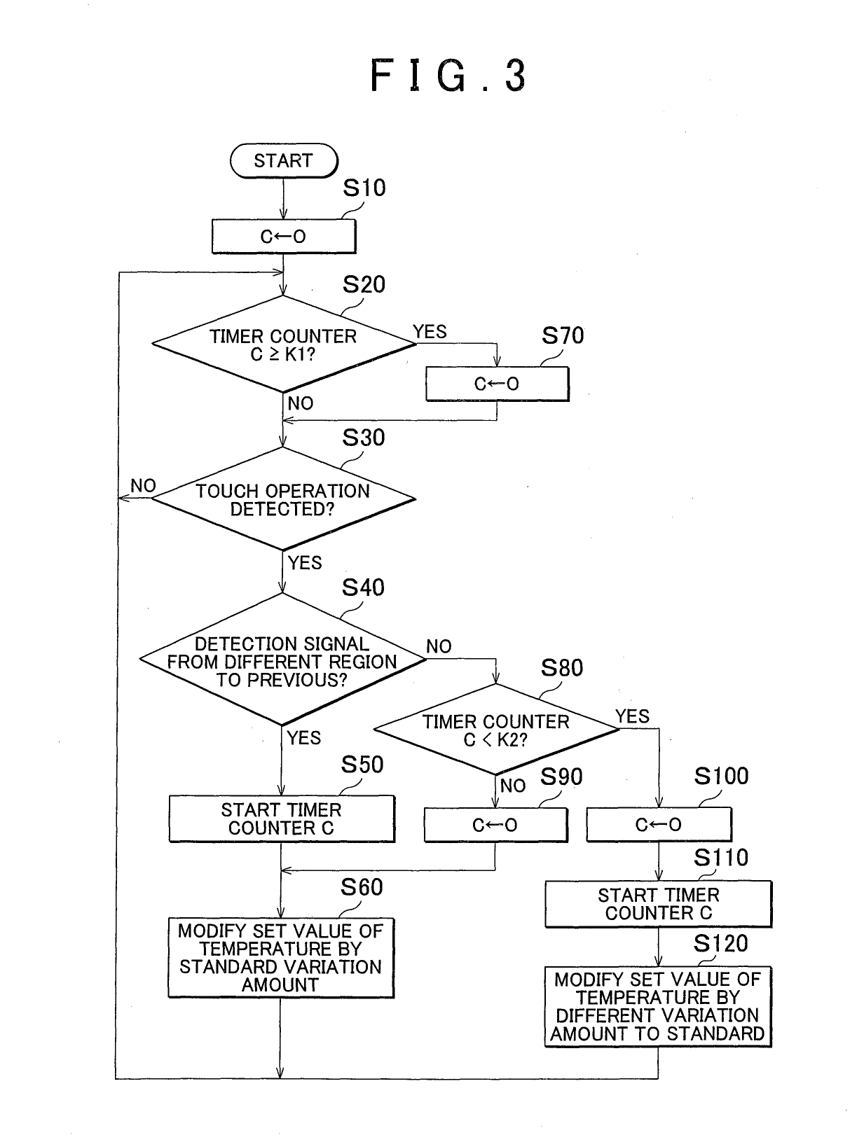

Next, functions of the input apparatus 10 configured as described above will be described using a flowchart shown in FIG. 3. The flowchart shown in FIG. 3 is a flowchart of a set value modification program executed by the CPU 40 of the input apparatus 10 in the air-conditioning control display mode or the audio control display mode.

Note that a case in which the input apparatus 10 is operated in the air-conditioning control display mode shown in FIG. 2 will be described below. The set value modification program is activated when a power supply of the input apparatus 10 is switched ON.

In S10, the CPU 40 resets a count value of a timer counter C provided in the CPU 40 to 0, whereupon the program advances to S20. Note that in this embodiment, the timer counter C is a free run counter. A count period of the timer counter C is a short period of several milliseconds or several tens of milliseconds, for example. The timer counter C serves as a measurement unit.

In S20, a determination is made as to whether or not the count value of the timer counter C has equaled or exceeded a fixed value K1 or reached overflow. Note that the fixed value K1 is larger than a threshold K2 to be described below (K1>K2). The fixed value K1 is a value for determining roughly whether or not consecutive touch operations (input operations) have been performed. When the count value equals or exceeds the fixed value K1, the CPU 40 determines that consecutive touch operations have not been performed. Overflow may occur at a count value exceeding the fixed value K1.

When the count value of the timer counter C has reached overflow or equaled or exceeded the fixed value K1, this indicates that a considerable amount of time has elapsed following a previous touch operation. When the count value of the timer counter C has reached overflow or equaled or exceeded the fixed value K1 in S20, the CPU 40 resets the count value of the timer counter C to 0 in S70, whereupon the program advances to S30. When the count value of the timer counter C has not reached overflow or is smaller than the fixed value K1, the program advances to S30. Accordingly, when the program advances from S10 to S20 after the power supply is switched ON for the first time, “NO” is determined in S20, after which the program advances to S30.

In S30, the CPU 40 determines whether or not a touch operation has been performed. When a touch operation is performed, a position detection signal is output from the region of the touch panel 30 in which the touch operation was performed, and therefore the CPU 40 determines in S30 whether or not a position detection signal has been input.

When it is determined in S30 that a position detection signal has not been input, or in other words that a touch operation has not been performed, the CPU 40 returns to S20. Hence, when a touch operation has not been performed, the CPU 40 repeats the processing of S20 and S30 or the processing of S20, S70, and S30. After determining in S30 that a position detection signal has been input, the CPU 40 advances to S40.

In S40, the CPU 40 determines whether or not the input position detection signal is the first position detection signal to be input after switching the power supply of the input apparatus 10 ON. Further, when the input position detection signal is not the first position detection signal, the CPU 40 determines whether or not the input position detection signal indicates a different region to a region of the previous touch operation.

When it is determined that the input position detection signal is the first position detection signal or that the input position detection signal is not the first position detection signal but indicates a different region to the previously input position detection signal, the CPU 40 advances to S50. In S50, the CPU 40 causes the timer counter C to start counting. When the input position detection signal is the first position detection signal, the count value of the timer counter C has already been reset in S10, and therefore the CPU 40 directly causes the timer counter C to start counting. After determining in S40 that the input position detection signal is not the first position detection signal but indicates a different region to the previously input position detection signal, on the other hand, the CPU 40 resets the count value of the timer counter C and then causes the timer counter C to start counting.

Following the processing of S50, the CPU 40 outputs a temperature setting signal for varying the set value of the temperature by a standard variation amount (also referred to as a first variation amount) to the air-conditioning controller 60 in S60. The air-conditioning controller 60 varies the spatial temperature in the vehicle cabin by controlling the air-conditioning apparatus 70 on the basis of the temperature setting signal.

More specifically, when the newest position detection signal indicates a site of the touch panel 30 corresponding to the guide display region 24a in FIG. 2, since the guide display region 24a is the region for increasing the current set value of the temperature, the CPU 40 outputs a temperature setting signal for increasing the set value of the temperature by the first variation amount to the air-conditioning controller 60. The air-conditioning controller 60 then increases the spatial temperature in the vehicle cabin on the driving seat side by controlling the air-conditioning apparatus 70 on the basis of the temperature setting signal.

Further, when the newest position detection signal indicates the site of the touch panel 30 corresponding to the guide display region 24a, the CPU 40 controls the display device 20 to increase the set value of the temperature displayed in the display region 22b by the first variation amount. In this embodiment, the first variation amount is set at 0.5 degrees. Hence, the set value of the temperature currently displayed in the display region 22b is increased by 0.5 degrees. In the example of FIG. 2, the current set value of the temperature is 24.0 degrees, and therefore the CPU 40 modifies the set value of the temperature displayed in the display region 22b of the display device 20 to 24.5 degrees.

When the newest position detection signal indicates a site of the touch panel 30 corresponding to the guide display region 24b in FIG. 2, for example, since the guide display region 24b is the region for reducing the current set value of the temperature, the CPU 40 outputs a temperature setting signal for reducing the set value of the temperature by the first variation amount to the air-conditioning controller 60. The air-conditioning controller 60 then reduces the spatial temperature in the vehicle cabin on the driving seat side by controlling the air-conditioning apparatus 70.

Further, when the newest position detection signal indicates the site of the touch panel 30 corresponding to the guide display region 24b, the CPU 40 controls the display device 20 to reduce the set value of the temperature displayed in the display region 22b by the first variation amount. In this embodiment, the first variation amount is set at 0.5 degrees. Hence, the set value of the temperature currently displayed in the display region 22b is reduced by 0.5 degrees. In the example of FIG. 2, the current set value of the temperature is 24.0 degrees, and therefore the CPU 40 modifies the set value of the temperature displayed in the display region 22b of the display device 20 to 23.5 degrees.

Note that in the above example, cases in which touch operations are detected in sites of the touch panel 30 corresponding to the guide display regions 24a, 24b were described, but likewise when a touch operation is detected in a site of the touch panel 30 corresponding to the guide display region 23a or 23b, the CPU 40 controls the display device 20 to increase or reduce the set value of the temperature currently displayed in the display region 22a by the first variation amount and outputs a temperature setting signal for varying the set value of the temperature by the first variation amount to the air-conditioning controller 60. As a result, the air-conditioning controller 60 varies the spatial temperature in the vehicle cabin on the front passenger seat side by controlling the air-conditioning apparatus 70.

Following the processing of S60, the CPU 40 returns to S20. When, in S40, the input position detection signal is not the first position detection signal to be input after switching the power supply of the input apparatus 10 ON and the input position detection signal indicates an identical region to the position detection signal input in the previous touch operation, the CPU 40 determines “NO” and advances to S80.

In S80, the CPU 40 determines whether or not the count value of the timer counter C is smaller than the threshold K2. When the count value of the timer counter C equals or exceeds the threshold K2, the CPU 40 resets the count value of the timer counter C in S90 and then advances to S60.

When the count value of the timer counter C is smaller than the threshold K2, or in other words when the input position detection signal indicates the same region as the position detection signal input in the previous touch operation and a time interval between the previous touch operation and the current touch operation is smaller than a predetermined threshold, it may be considered that touch operations have been performed consecutively at a short time interval. Hence, when the count value of the timer counter C is smaller than the threshold K2 in S80, the CPU 40 determines “YES” in S80 and then resets the count value of the timer counter C in S100. Further, the CPU 40 causes the timer counter C to start counting in S110, and then advances to S120.

In S120, the CPU 40 outputs a temperature setting signal for varying the temperature set value by a different variation amount (also referred to as a second variation amount) to the standard variation amount to the air-conditioning controller 60. The air-conditioning controller 60 varies the spatial temperature in the vehicle cabin by controlling the air-conditioning apparatus 70 on the basis of the temperature setting signal.

More specifically, when the newest position detection signal indicates the site of the touch panel 30 corresponding to the guide display region 24a in FIG. 2, the CPU 40 outputs a temperature setting signal for increasing the set value of the temperature by the second variation amount to the air-conditioning controller 60. The air-conditioning controller 60 then increases the spatial temperature in the vehicle cabin on the driving seat side by controlling the air-conditioning apparatus 70 on the basis of the temperature setting signal.

Further, the CPU 40 controls the display device 20 to increase the set value of the temperature displayed in the display region 22b by the second variation amount. In this embodiment, the second variation amount is set at 1.0 degrees. Hence, the set value of the temperature currently displayed in the display region 22b is increased by 1.0 degrees. In the example of FIG. 2, the current set value of the temperature is 24.0 degrees, and therefore the CPU 40 modifies the set value of the temperature displayed in the display region 22b of the display device 20 to 25.0 degrees.

When the newest position detection signal indicates the site of the touch panel 30 corresponding to the guide display region 24b in FIG. 2, for example, the CPU 40 outputs a temperature setting signal for reducing the set value of the temperature by the second variation amount to the air-conditioning controller 60. The air-conditioning controller 60 then reduces the spatial temperature in the vehicle cabin on the driving seat side by controlling the air-conditioning apparatus 70 on the basis of the temperature setting signal.

Further, the CPU 40 controls the display device 20 to reduce the set value of the temperature displayed in the display region 22b by the second variation amount. In this embodiment, the second variation amount is set at 1.0 degrees. Hence, the set value of the temperature currently displayed in the display region 22b is reduced by 1.0 degrees. In the example of FIG. 2, the current set value of the temperature is 24.0 degrees, and therefore the CPU 40 modifies the set value of the temperature displayed in the display region 22b of the display device 20 to 23.0 degrees.

Note that in the above example, cases in which touch operations are detected in sites of the touch panel 30 corresponding to the guide display regions 24a, 24b were described, but likewise when a touch operation is detected in a site of the touch panel 30 corresponding to the guide display region 23a or 23b, the CPU 40 controls the display device 20 to increase or reduce the set value of the temperature currently displayed in the display region 22a by the second variation amount and outputs a temperature setting signal for varying the set value of the temperature by the second variation amount to the air-conditioning controller 60. The air-conditioning controller 60 then varies the spatial temperature in the vehicle cabin on the front passenger seat side by controlling the air-conditioning apparatus 70 on the basis of the temperature setting signal. Following the processing of S120, the CPU 40 returns to S20.

Next, a case in which the switch 50 is operated to set the display device 20 of the input apparatus 10 in the audio control display mode will be described with reference to FIGS. 3 and 4. Note that a flowchart of a set value modification program executed in the audio control display mode is roughly identical to the flowchart of the program executed in the air-conditioning control display mode, but includes partial differences on which the following description will focus.

As shown in FIG. 4, in the audio control display mode, nothing is displayed in the operation direction guide display regions 23a, 23b on the display screen 21 of the display device 20, while shapes (arrow shapes, for example) indicating operation directions are displayed in the operation direction guide display regions 24a, 24b. Further, as shown in FIG. 4, nothing is displayed in the left side display region 22a in the upper portion of the display screen 21 of the display device 20 while the set value of the sound volume of the audio apparatus 80 is displayed in the right side display region 22b.

In the audio control display mode, the processing performed in S10, S20, S40, S50, S70, S80, S90, 5100, and S110 of the flowchart in FIG. 3 is identical to that of the air-conditioning control display mode, while the processing of S30, S60, and S120, to be described below, is different.

In S30, a determination is made as to whether or not a position detection signal has been input from the sites of the touch panel 30 corresponding to the guide display regions 24a, 24b. Note that the CPU 40 ignores position detection signals input from sites of the touch panel 30 corresponding to the guide display regions 23a, 23b.

In S60, a standard variation amount (a first variation amount) of the sound volume is set at “1”. However, the first variation amount is not limited to “1”, and may be a numerical value with a decimal point, such as “0.5”, for example.

In S60, the CPU 40 outputs a sound volume setting signal for varying the set value by the first variation amount to the audio apparatus 80. The audio apparatus 80 varies the sound volume on the basis of the sound volume setting signal. More specifically, when the newest position detection signal indicates the site of the touch panel 30 corresponding to the guide display region 24a in FIG. 2, the audio apparatus 80 increases the sound volume, and when the newest position detection signal indicates the site of the touch panel 30 corresponding to the guide display region 24b, the audio apparatus 80 reduces the sound volume.

Further, when the newest position detection signal indicates the site of the touch panel 30 corresponding to the guide display region 24a, the CPU 40 controls the display device 20 to increase the set value of the sound volume displayed in the display region 22b by the first variation amount, for example “1”. Hence, in the example of FIG. 4, the set value of the sound volume currently displayed in the display region 22b is modified from “18” to “19”, i.e. an increase of “1”.

Further; when the newest position detection signal indicates the site of the touch panel 30 corresponding to the guide display region 24b, the CPU 40 controls the display device 20 to reduce the set value of the sound volume displayed in the display region 22b by the first variation amount, for example “1”. Hence, in the example of FIG. 4, the set value of the sound volume currently displayed in the display region 22b is modified from “18” to “17”, i.e. a reduction of “1”.

In S120, a different variation amount (a second variation amount) to the standard is set at “2”, for example. Note that the second variation amount is not limited to “2”. The second variation amount may be larger than the first variation amount, such as “3” or more.

When the newest position detection signal indicates the site of the touch panel 30 corresponding to the guide display region 24a, the CPU 40 controls the display device 20 to increase the set value of the sound volume displayed in the display region 22b by the second variation amount, for example “2”. Hence, in the example of FIG. 4, the set value of the sound volume currently displayed in the display region 22b is modified from “18” to “20”, i.e. an increase of “2”.

Further, in S120, the CPU 40 outputs a sound volume setting signal for varying the set value of the sound volume by the second variation amount to the audio apparatus 80. The audio apparatus 80 increases the sound volume on the basis of the sound volume setting signal.

When the newest position detection signal indicates the site of the touch panel 30 corresponding to the guide display region 24b, the CPU 40 controls the display device 20 to reduce the set value of the sound volume displayed in the display region 22b by the second variation amount, for example “2”. Hence, in the example of FIG. 4, the set value of the sound volume currently displayed in the display region 22b is modified from “18” to “16”, i.e. a reduction of “2”.

Further, in S120, the CPU 40 outputs a sound volume setting signal for varying the set value of the sound volume by the second variation amount to the audio apparatus 80. The audio apparatus 80 reduces the sound volume on the basis of the sound volume setting signal.

This embodiment is configured as follows.

(1) The input apparatus 10 according to this embodiment includes the display device 20 serving as a display unit, and the touch panel 30 disposed on a display screen of the display device 20 in order to detect a touch operation. Further, The input apparatus 10 includes the CPU 40 serving as a processing unit configured to modify set values of the spatial temperature in the vehicle cabin and the sound volume (control items of the control apparatus) displayed on the display device 20 in accordance with touch operations detected by the touch panel 30, and output signals indicating modified set values to the control apparatuses that control the spatial temperature in the vehicle cabin and the sound volume.

The input apparatus 10 also includes the timer counter C that measures the time interval between consecutive touch operations (the time interval from a previous touch operation). The CPU 40 of the input apparatus 10 is configured to set variation amounts by which the set values of the spatial temperature in the vehicle cabin and the sound volume are varied such that the variation amounts when the time interval is smaller than the threshold K2 differ from the variation amounts when the time interval equals or exceeds the threshold K2.

As a result, with the input apparatus 10 according to this embodiment, operability during operations to modify the set values of the spatial temperature in the vehicle cabin and the sound volume can be improved by means of a simple configuration without the need to increase the length of the touch panel 30. Further, the variation amounts of the set values of the spatial temperature in the vehicle cabin and the sound volume can be varied simply by changing the time interval between consecutive touch operations from a smaller time interval than the threshold K2 to a time interval that equals or exceeds the threshold K2 or from a time interval that equals or exceeds the threshold K2 to a smaller time interval than the threshold K2.

(2) When the time interval is smaller than the threshold K2, the CPU 40 of the input apparatus 10 according to this embodiment is configured to modify the set values by a larger variation amount than the variation amount of the set values employed when the time interval equals or exceeds the threshold K2. Therefore the set values of the control items, such as the spatial temperature in the vehicle cabin and the sound volume, can be modified quickly.

### Second Embodiment

Next, a second embodiment will be described. A hardware configuration of the input apparatus 10 according to the second embodiment is identical to that of the first embodiment, but a software configuration differs from the first embodiment, as will be described below.

In the first embodiment, when the time interval between touch operations is smaller than the threshold K2, the set value is modified by a larger variation amount than the variation amount of the set value used when the time interval equals or exceeds the threshold K2. In the second embodiment, however, when the time interval between touch operations is smaller than the threshold K2, the set value is reduced by a smaller variation amount than the variation amount of the set value used when the time interval equals or exceeds the threshold K2.

In other words, the processing of S60 is performed in S120 on the flowchart shown in FIG. 3, and the processing of S120 is performed in S60. In so doing, when the time interval between touch operations is smaller than the threshold K2, the set value is reduced by a smaller variation amount than the variation amount of the set value used when the time interval between touch operations equals or exceeds the threshold K2, and therefore fine reductions can be made to the set values of the spatial temperature in the vehicle cabin and the sound volume (the control items).

Note that the invention is not limited to the embodiments described above and may be modified as follows. The input apparatus according to the first and second embodiments doubles as the input apparatus for the air-conditioning apparatus of the vehicle and the input apparatus for the audio apparatus, but the input apparatus may be used exclusively for either the air-conditioning apparatus of the vehicle or the audio apparatus. In this case, the switch may be omitted from the embodiments described above such that the input apparatus functions only as an input apparatus for the air-conditioning apparatus of the vehicle or the audio apparatus.

In the first and second embodiments, the input apparatus 10 is disposed in a location where a person sitting in the driving seat or the front passenger seat can operate the input apparatus 10 easily, but the input apparatus 10 may be provided in a location of the vehicle cabin near a rear seat of the vehicle. In the first and second embodiments, the touch panel 30 is provided on the display screen of the display device 20, but the display device 20 and the touch panel 30 may be provided in separate locations. In the first and second embodiments, the timer counter C is a free run counter, and in S20, a determination is made as to whether or not the count value thereof exceeds the fixed value. Then, when the count value exceeds the fixed value, the processing advances to S70, where the count value is reset. Instead of this configuration, however, the timer counter C may be of a type that resets the count value to 0 automatically when the count value reaches the fixed value. In this case, S20 and S70 of the flowchart in FIG. 3 may be omitted.

In the above embodiments, the variation amount that differs from the standard variation amount for increasing the set value and the variation amount that differs from the standard variation amount for reducing the set value are set at numerical values having identical absolute values (“1” in the above embodiments), but the variation amounts that differ from the standard variation amounts are not limited to identical numerical values and may take different numerical values.

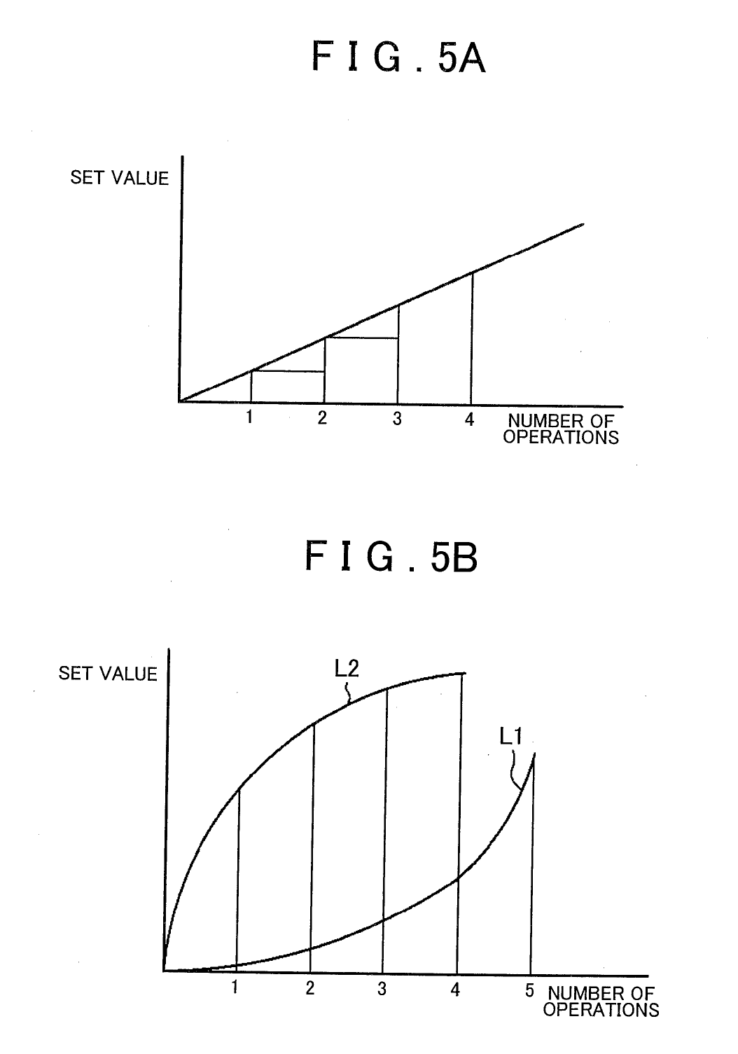

In the first embodiment, when three or more touch operations are performed consecutively and the time intervals between the touch operations are all smaller than the threshold K2, the variation amounts of the set value are identical in all of the touch operations (see solid line in FIG. 5A).

Instead of this configuration, a history of the number of “YES” determinations in S80 may be recorded, and when consecutive “YES” determinations are obtained in S80, the variation amount of the set value may be increased gradually as the number of consecutive “YES” determinations increases.

For example, when, in the air-conditioning control display mode, a “YES” determination is obtained in S80 for a first time, two consecutive times, three consecutive times, and N consecutive times, the variation amount of the set value may be set at a variation amount D for the first time, a variation amount D+d1 for the second consecutive time, a variation amount D+d2 for the third consecutive time, and a variation amount D+dN−1 for the Nth consecutive time. Note that dN−1 may be a positive integer or a positive value with a decimal point.

When, in this case, the value of dN−1 is increased as N increases, a set value indicated by a curve L1 in FIG. 5B is obtained. Further, when the value of dN−1 is reduced as N increases, a set value indicated by a curve L2 in FIG. 5B is obtained.

Note that the audio control display mode may be configured similarly. In the second embodiment, when three or more touch operations are performed consecutively and the time intervals between the touch operations are all smaller than the threshold K2, the variation amounts of the set value are identical in all of the touch operations.

Instead of this configuration, a history of the number of “YES” determinations in S80 may be recorded, and when consecutive “YES” determinations are obtained in S80, the variation amount of the set value may be reduced gradually as the number of consecutive “YES” determinations increases.

For example, when, in the air-conditioning control display mode, a “YES” determination is obtained in S80 for a first time, two consecutive times, three consecutive times, and N consecutive times, the variation amount of the set value may be set at a variation amount D for the first time, a variation amount D+d1 for the second consecutive time, a variation amount D+d2 for the third consecutive time, and a variation amount D+dN−1 for the Nth consecutive time. Note that dN−1 may be a positive integer or a positive value with a decimal point.

Note that the audio control display mode may be configured similarly.

1. An input apparatus comprising:
a display unit that displays a set value set in relation to a control item of a control apparatus;
a touch panel that detects a touch operation;
a processing unit configured to modify the set value displayed on the display unit in accordance with the touch operation detected by the touch panel, and output a signal indicating the modified set value to the control apparatus; and
a measurement unit that measures a time interval between the touch operation and a previous touch operation,
wherein the processing unit is configured to set a variation amount by which the set value is varied such that the variation amount of the set value when the time interval is smaller than a threshold and the variation amount of the set value when the time interval equals or exceeds the threshold differ from each other.

2. The input apparatus according to claim 1, wherein the processing unit is configured to increase the variation amount of the set value when the time interval is smaller than the threshold above the variation amount of the set value when the time interval equals or exceeds the threshold.

3. The input apparatus according to claim 2, wherein, when a plurality of short time interval touch operations, each of which is the touch operation with the time interval smaller than the threshold, are performed consecutively, the processing unit is configured to increase the variation amount of the set value in accordance with the short time interval touch operation performed subsequently above the variation amount of the set value in accordance with the short time interval touch operation performed initially.

4. The input apparatus according to claim 1, wherein the processing unit configured to reduce the variation amount of the set value when the time interval is smaller than the threshold below the variation amount of the set value when the time interval equals or exceeds the threshold.

5. The input apparatus according to claim 4, wherein, when a plurality of short time interval touch operations, each of which is the touch operation with the time interval smaller than the threshold, are performed consecutively, the processing unit is configured to reduce the variation amount in accordance with the short time interval touch operation performed subsequently below the variation amount in accordance with the short time interval touch operation performed initially.

6. The input apparatus according to claim 1, wherein the touch panel is disposed on a display screen of the display unit.

7. An input apparatus processing method comprising:
detecting a touch operation on a touch panel;
modifying a set value set in relation to a control item of a control apparatus, which is displayed by a display unit, in accordance with the touch operation detected by the touch panel;
outputting a signal indicating the modified set value to the control apparatus;
measuring a time interval between the touch operation and a previous touch operation; and
modifying a variation amount by which the set value is varied such that the variation amount of the set value when the time interval is smaller than a threshold and the variation amount of the set value when the time interval equals or exceeds the threshold differ from each other.
